(19) United States
(12) Patent Application Publication
(10) Pub. No.: US 2007/0127961 A1
(43) Pub. Date: Jun. 7, 2007

(54) Method and apparatus for copying double-sided document

(75) Inventors: Ho-sung Han, Suwon-si (KR); Seung-bae Yang, Gwacheon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/582,478

(22) Filed: Oct. 18, 2006

(30) Foreign Application Priority Data
Dec. 2, 2005 (KR) 2005-0116884

(51) Int. Cl. G03G 15/00

(52) U.S. Cl. 399/364

(57) ABSTRACT

A method and apparatus for copying a double-sided document are provided to obtain a double-sided or one-sided copy by using a copying apparatus having a duplex automatic document feeder (DADF), in which an original document is scanned, an odd page image and an even page image of the scanned original document are displayed, an input selecting orientation of the even page image is received, and the odd page and the even page are printed according to the selected orientation. Therefore, when the double-sided or one-sided copy is made from the double-sided original document, the finished copy can be obtained without a reversed even page, thereby eliminating an inconvenience of arranging the page orientation of the finished copy. Further, consumption of paper or a cartridge can be reduced since the finished copy can be obtained without a reversed even page.

### CROSS-REFERENCE TO RELATED PATENT APPLICATION

This application claims the benefit under 35 U.S.C. § 119(a) of Korean Patent Application No. 10-2005-0116884, filed on Dec. 2, 2005, in the Korean Intellectual Property Office, the entire disclosure of which is hereby incorporated by reference.

### BACKGROUND OF THE INVENTION

1. Field of the Invention

The present invention relates to a method and apparatus for copying a document. More particularly, the present invention relates to a method and apparatus for copying a double side document in a desired manner when making a double-sided or one-sided copy from the double-sided document.

2. Description of the Related Art

A conventional document copier can perform copying with 1-1, 2-1, 2-1R, 1-2, 2-2, and 2-2R options, if the document copier includes a duplex automatic document feeder (DADF) and supports duplex printing. Here, 1-1 means copying an one-sided original document onto one side of paper, 2-1 means copying a double-sided original document onto one side of paper, 2-1R means copying a double-sided original document onto one side of paper in a 180-degree rotated orientation, 1-2 means copying an one-sided original document onto both sides of paper, 2-2 means copying a double-sided original document onto both sides of paper, and 2-2R means copying a double-sided original document onto both sides of paper in a 180-degree rotated orientation.

Examples of double-sided documents include a short edge type double-sided document as shown in FIG. 1A and a long edge type double-sided document as shown in FIG. 1B. If copied with the 2-1 option, the short edge type double-sided document shown in FIG. 1A is normally output as shown in FIG. 2A. If copied with the 2-1R option, the short edge type double-sided document shown in FIG. 1A is output as shown in FIG. 2B with a reversed even page. On the contrary, if the long edge type double-sided document shown in FIG. 1B is copied with the 2-1 option, it is output as shown in FIG. 2B with a reversed even page. If the long edge type double-sided document shown in FIG. 1B is copied with the 2-1R option, it is normally output as shown in FIG. 2A. Therefore, a user should select the 2-1 copying if an original document is a short edge type document and a 2-1R copying if the original document is a long edge type document.

However, if the user does not correctly know how to select these copy options, a copy with reversed even page(s) can be output. Further, if a document with many pages is copied in an improper option, it may take a lot of time to arrange the copied document in proper orientation.

Accordingly, there is a need for an improved method and apparatus for copying a double-sided document without a reversed even page.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and apparatus for copying a double-sided document that can prevent an even page from being printed in a reversed orientation when making a double-sided or one-sided copy from the double-sided document.

According to an aspect of exemplary embodiments of the present invention, there is provided a method of making a double-sided or one-sided copy from a double-sided original document using a copying apparatus with a DADF (duplex automatic document feeder), in which the original document is scanned; an odd page image and an even page image of the scanned original document are displayed; an input selecting orientation of the even page image is received; and the odd page and the even page are printed according to the selected orientation.

In an exemplary implementation, the orientation may be one of a zero-degree rotated orientation and a 180-degree rotated orientation, and the original document may include at least one page.

In another exemplary implementation, the displaying may include rotating a second page of the scanned images, generating a preview image for displaying scanned images and the scanned images with the rotated second page, and displaying the preview image.

According to another aspect of exemplary embodiments of the present invention, there is provided a method of making a double-sided or one-sided copy from a double-sided original document using a copying apparatus with a DADF, in which a first page and a second page of the original document are scanned and the scanned first and second pages are printed; a message asking whether the printing is to be continued according to the printed first and second pages or the printing is to be performed by rotating the second page is displayed; an input selecting one of the continuing printing and the rotation printing is received; and if the continuing printing is selected, the printing according to scanned images is performed, and if the rotation printing is selected, the printing by rotating an even page of the scanned images by 180 degrees is performed.

According to a further aspect of exemplary embodiments of the present invention, there is provided an apparatus with a DADF for making a double-sided or one-sided copy of a double-sided original document, in which a scanning unit scans images of the original document; a preview image generating unit generates a preview image for displaying an odd page image and an even page image of the scanned images; a user interface unit displays the preview image generated by the preview image generating unit and receives an input selecting orientation of the even page image; and a control unit controls printing of the odd page image and the even page image according to the selected orientation.

According to a still a further aspect of exemplary embodiments of the present invention, there is provided an apparatus with a DADF for making a double-sided or one-sided copy of a double-sided original document, in which a scanning unit scans images of the original document; a control unit controls printing of a first page and a second page of the images scanned by the scanning unit; and a user interface unit displays a message asking whether the printing is to be continued according to the printed first and second pages or the printing is to be performed by rotating the second page, wherein if the continuing printing is selected, the control unit controls the printing to be performed according to the scanned images, and if the rotation printing is selected, the control unit controls the printing to be performed by rotating an even page of the scanned images by 180 degrees.

### BRIEF DESCRIPTION OF THE DRAWINGS

The above and other objects, features and advantages of certain exemplary embodiments of the present invention will be more apparent from the following description taken in conjunction with the accompanying drawings, in which:

FIG. 1A shows a short edge type double-sided document;

FIG. 1B shows a long edge type double-sided document;

FIG. 2A shows a duplicate obtained by copying the short edge type double-sided document of FIG. 1A onto one side of paper;

FIG. 2B shows a duplicate obtained by copying the short edge type double-sided document of FIG. 1 onto one side of paper in a 180-degree rotated orientation;

FIG. 3 is a block diagram showing a structure of an apparatus for copying a double-sided document according to an exemplary embodiment the present invention;

FIG. 4 is a flowchart showing a method of copying a double-sided document according to an exemplary embodiment of the present invention;

FIG. 5 shows a screen displayed on a user interface unit in operation 430 of FIG. 4;

FIG. 6 is a flowchart showing a method of copying a double-sided document according to an exemplary embodiment of the present invention; and

FIG. 7 shows a screen displayed on a user interface unit in operation 630 of FIG. 6.

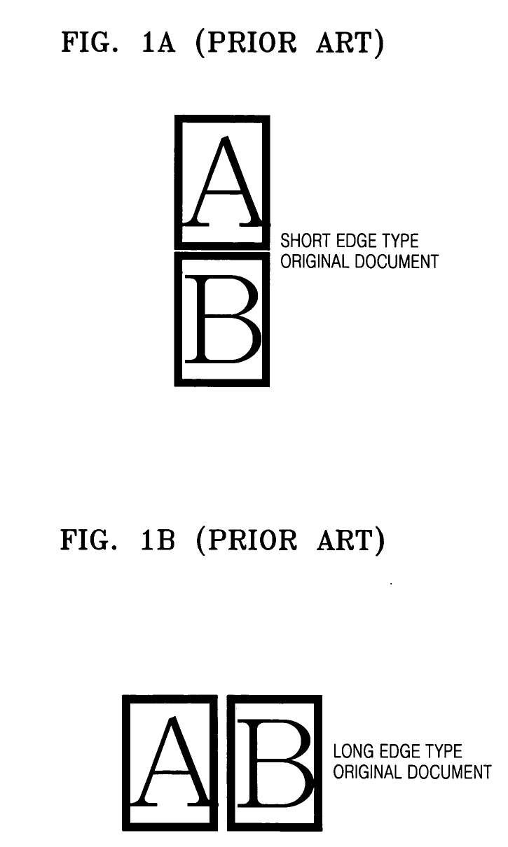

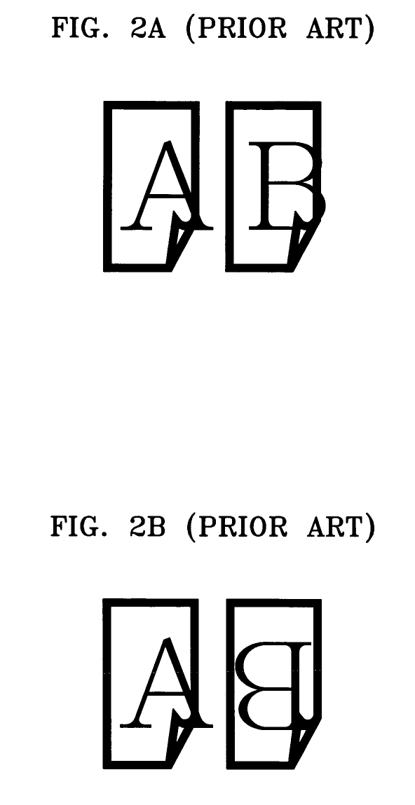

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

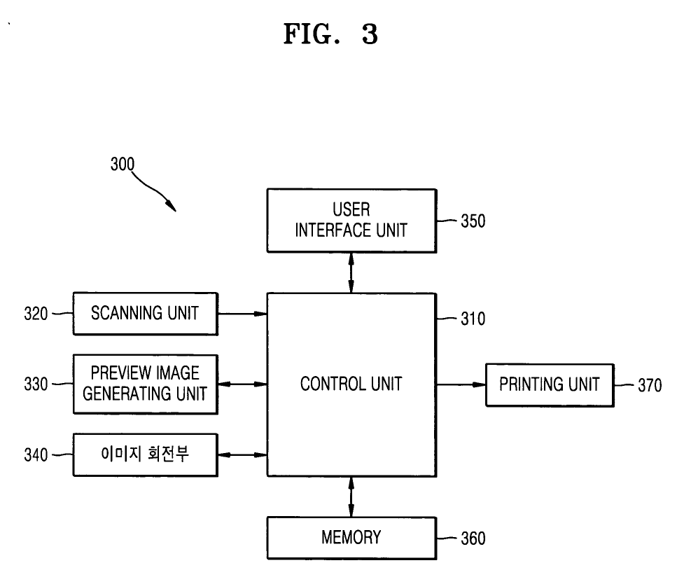

FIG. 3 is a block diagram showing a structure of an apparatus for copying a double-sided document according to an exemplary embodiment of the present invention.

Referring to FIG. 3, an apparatus 300 for copying a double-sided document includes a control unit 310, a scanning unit 320, a preview image generating unit 330, an image rotation unit 340, a user interface unit 350, a memory 360, and a printing unit 370.

In an exemplary embodiment of the present invention, the user interface unit 350 includes a liquid crystal display (LCD, not shown) to show a preview image screen for a user to check scanned original documents prior to printing.

The control unit 310 controls the overall operation of the apparatus 300. The scanning unit 320 scans the original document and sends scanned images to the control unit 310 after converting the scanned images into a control unit readable format. The preview image generating unit 330 generates a preview image to display the scanned images and the scanned images with a rotated second page on the user interface unit 350. The user interface unit 350 displays the preview image generated by the preview image generating unit 330. A user can select the orientation of the second page using the preview image displayed on the user interface unit 350. The orientation is a zero-degree rotated orientation or a 180-degree rotated orientation. That is, the user can select either the scanned images or the scanned images with the rotated second page. The user interface unit 350 may be configured with a touch screen to receive a selection instruction. Further, the user interface unit 350 may receive the selection instruction through manipulation buttons (not shown). The memory 360 stores image data of the scanned images.

The control unit 310 controls printing of odd pages and even pages. Here, the even pages are printed according to the selected orientation through the user interface unit 350. That is, if the scanned images are selected through the user interface unit 350, the control unit 310 controls the printing according to the selected scanned images, and if the scanned images with the rotated second page are selected through the user interface unit 350, the control unit 310 controls the printing to be performed with rotated even pages.

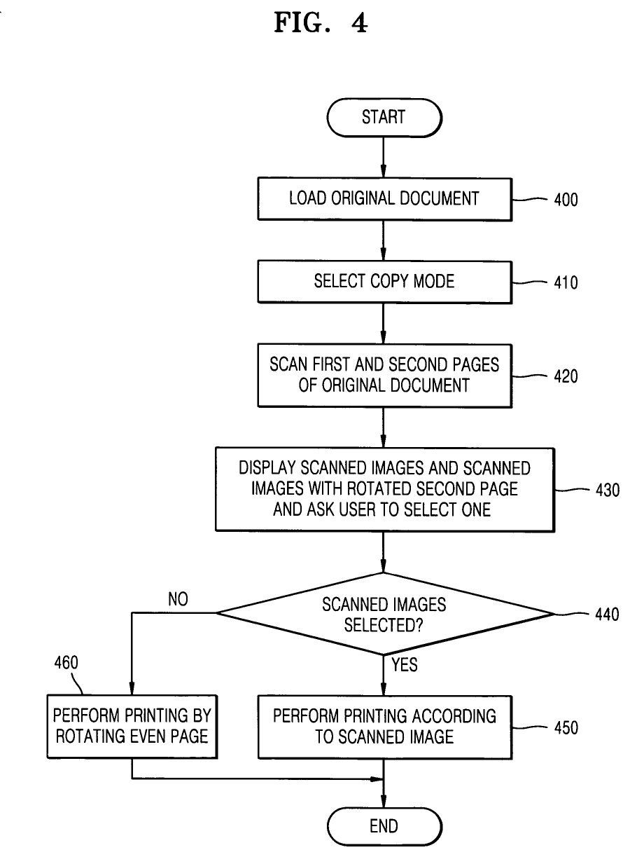

The printing unit 370 prints the scanned images or the scanned images with rotated even pages under the control of the control unit 310. An operation of the document copying apparatus will be described later in detail according to an exemplary embodiment of the present invention with reference to a flowchart of FIG. 4, showing a method of copying a double-sided document according to an exemplary embodiment of the present invention.

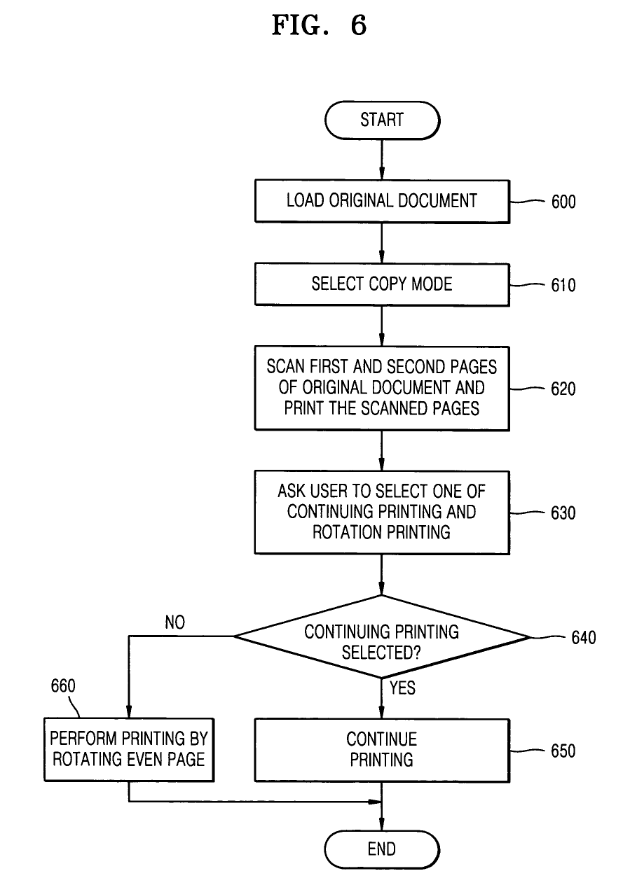

In an exemplary implementation, when the user interface unit 350 is not provided with an LCD, a first page and a second page of scanned images are printed in advance for a user to check whether the pages are normally printed. In this case, the document copying apparatus 300 does not include the preview image generating unit 330. An operation of the document copying apparatus will be described later in detail according to an exemplary embodiment of the present invention with referent to a flowchart of FIG. 6, showing a method of copying a double-sided document according to an exemplary embodiment of the present invention.

FIG. 4 is a flowchart showing a method of copying a double-sided document according to an exemplary embodiment of the present invention. The document copying method and the operation of the document copying apparatus will now be described in detail with reference to FIGS. 3 and 4.

In step 400, a user loads an original document on a document tray (not shown) of the document copying apparatus 300. In step 410, the user selects a copy mode. The user can select a 2-1 copy option for making a one-sided copy of the double-sided original document or a 2-2 copy option for making a double-sided copy of the double-sided original document.

When the user selects the copy mode, the scanning unit 320 produces image data by scanning a first page and a second page of the original document in step 420. The images data are stored in the memory 360 under the control of the control unit 310. In an exemplary implementation, more pages of the original document, besides the first and second pages, can be scanned and stored in the memory 360 depending on the capacity of the memory 360.

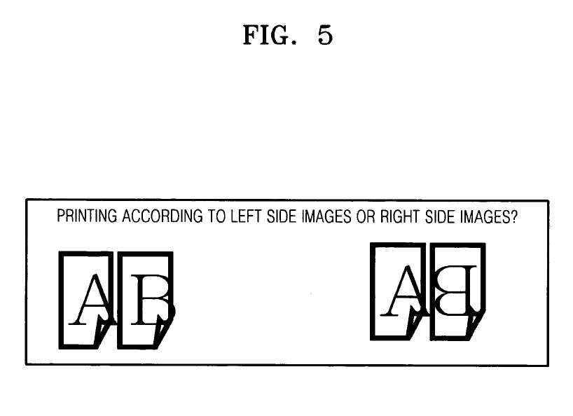

In step 430, the control unit 310 controls the user interface unit 350 to display the scanned images and the scanned images with a rotated second page, and to display a message for asking the user to select one of the scanned images or the scanned images with the rotated second page. The control unit 310 rotates the second page of the scanned images, and the preview image generating unit 330 generates a preview image for displaying the scanned images and the scanned images with the rotated second page. The control unit 310 sends a control instruction to the user interface unit 350 for displaying the preview image. FIG. 5 shows a screen displayed on the user interface unit 350. In the screen, the scanned images are presented in a left portion, and the scanned images with the rotated second page are presented in a right portion. In FIG. 5, when a short edge type original document is copied in the 2-1 mode, the left side images are normal, and the right side images are abnormal with a reversed second page. On the contrary, when a long edge type original document is copied in the 2-1 mode, the right side images may be normal images.

In step 440, the control unit 310 determines whether the user selected the scanned images or the scanned images with the rotated second page. If scanned images are selected, the control unit 310 controls the printing unit 370 to print the scanned images in step 450. If the scanned images are not selected, that is, if the scanned images with the rotated second page are selected, the control unit 310 rotates even pages and controls the printing unit 370 to print the image data with the rotated even pages in step 460.

FIG. 6 is a flowchart showing a method of copying a double-sided document according to an exemplary embodiment of the present invention. The document coping method and the operation of the document copying apparatus will now be described in detail with reference to FIGS. 3 and 6.

In step 600, a user loads an original document on a document tray (not shown) of the document copying apparatus 300. In step 610, the user selects a copy mode.

When the user selects the copy mode, the scanning unit 320 produces image data by scanning a first page and a second page of the original document, and the control unit 310 controls the printing unit 370 to print the first and second pages using the image data in step 620.

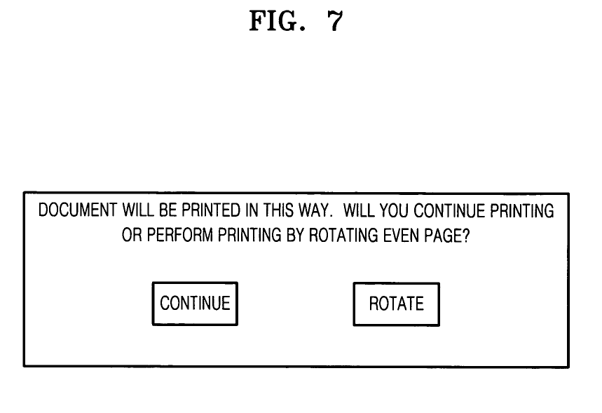

In step 630, the user interface unit 350 displays a message for asking the user to select one of a continuing printing and a rotation printing. Here, the user checks whether the second page is normally printed. FIG. 7 shows a screen displayed on the user interface unit 360. If the user interface unit 360 operates using a touch screen, the user can input a selection instruction by touching one of a continuing printing button or a rotation printing button on the touch screen. Further, the user can input the selection instruction using manipulation buttons of the user interface unit 350.

If the user selects the continuing printing in step 640 when the second page is normally printed, the printing unit 370 continues the printing according to the images scanned by the scanning unit 320 in step 650. If the user selects the rotation printing, the control unit 310 rotates even pages using the image rotation unit 340, and the printing unit 370 prints image data with rotated even pages in step 660. Here, the printing unit 370 prints the second page again.

According to the method and apparatus for copying a double-sided document of the exemplary embodiments of the present invention, when a double-sided or one-sided copy is made from a double-sided original document, a finished copy can be obtained without a reversed even page, thereby eliminating an inconvenience of arranging the page orientation of the finished copy. Further, consumption of paper or a cartridge can be reduced since the finished copy can be obtained without a reversed even page.

The exemplary embodiments of the present invention can also be embodied as computer-readable codes on a computer-readable recording medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, function programs, codes, and code segments for accomplishing the present invention can be easily construed as within the scope of the invention by programmers skilled in the art to which the present invention pertains.

While the present invention has been particularly shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A method of producing at least one of a double-sided and one-sided copy from a double-sided original document using a copying apparatus comprising a duplex automatic document feeder (DADF), the method comprising:
scanning an original document;
displaying an odd page image and an even page image of the scanned original document;
receiving an input selecting orientation of the even page image; and
printing the odd page and the even page according to the selected orientation.

2. The method of claim 1, wherein the orientation comprises at least one of a zero-degree rotated orientation and a 180-degree rotated orientation.

3. The method of claim 1, wherein the original document comprises at least one page.

4. The method of claim 1, wherein the displaying comprises:
rotating a second page of the scanned images;
generating a preview image for displaying scanned images and the scanned images with the rotated second page; and
displaying the preview image.

5. A method of producing at least one of a double-sided and one-sided copy from a double-sided original document using a copying apparatus comprising a duplex automatic document feeder DADF, the method comprising:
scanning a first page and a second page of an original document and printing the scanned first and second pages;
displaying a message for selecting at least one of the printing to be continued according to the printed first and second pages and a rotation printing to be performed by rotating the second page;
receiving an input selecting one of the continuing printing and the rotation printing; and
if the continuing printing is selected, performing the printing according to scanned images, and if the rotation printing is selected, performing the printing by rotating an even page of the scanned images by 180 degrees.

6. The method of claim 5, wherein the original document comprises at least one page.

7. The method of claim 5, wherein if the rotation printing is selected, the performing of the printing by rotating the even page starts with the second page.

8. An apparatus comprising a duplex automatic document feeder (DADF) for producing at least one of a double-sided and one-sided copy of a double-sided original document, the apparatus comprising:
a scanning unit for scanning images of an original document;
a preview image generating unit for generating a preview image for displaying an odd page image and an even page image of the scanned images;
a user interface unit for displaying the preview image generated by the preview image generating unit and receiving an input selecting orientation of the even page image; and
a control unit for controlling printing of the odd page image and the even page image according to the selected orientation.

9. The apparatus of claim 8, wherein the orientation comprises at least one of a zero-degree rotated orientation and a 180-degree rotated orientation.

10. The apparatus of claim 8, wherein the original document comprises at least one page.

11. An apparatus comprising a duplex automatic document feeder (DADF) for producing at least one of a double-sided and one-sided copy of a double-sided original document, the apparatus comprising:
a scanning unit for scanning images of an original document;
a control unit for controlling printing of a first page and a second page of the images scanned by the scanning unit; and
a user interface unit for displaying a message for selecting at least one of a continuing printing to be continued according to the printed first and second pages and a rotation printing to be performed by rotating the second page,
wherein if the continuing printing is selected, the control unit controls the printing to be performed according to the scanned images, and if the rotation printing is selected, the control unit controls the printing to be performed by rotating an even page of the scanned images by 180 degrees.

12. The apparatus of claim 11, wherein the original document comprises at least one page.

13. A computer-readable recording medium storing a computer program code for performing a method of producing at least one of a double-sided and one-sided copy from a double-sided original document using a copying apparatus comprising a duplex automatic document feeder (DADF), the method comprising:
scanning an original document;
displaying an odd page image and an even page image of the scanned original document;
receiving an input selecting orientation of the even page image; and
printing the odd page and the even page according to the selected orientation.

14. The method of claim 13, wherein the orientation comprises at least one of a zero-degree rotated orientation and a 180-degree rotated orientation.

15. The method of claim 13, wherein the original document comprises at least one page.

16. The method of claim 13, wherein the displaying comprises:
rotating a second page of the scanned images;
generating a preview image for displaying scanned images and the scanned images with the rotated second page; and
displaying the preview image.

17. An apparatus comprising a duplex automatic document feeder (DADF) for producing at least one of a double-sided and one-sided copy of a double-sided original document, the apparatus comprising:
a scanning unit for scanning images of an original document; and
a control unit for controlling at least one of printing of an odd page image and an even page image according to a selected orientation, and printing of a first page and a second page of the images scanned by the scanning unit.

18. The apparatus of claim 17, further comprising a preview image generating unit for generating a preview image for displaying the odd page image and the even page image of the scanned images.

19. The apparatus of claim 17, further comprising a user interface unit for displaying the preview image generated by the preview image generating unit and receiving an input selecting orientation of the even page image and displaying a message for selecting at least one of a continuing printing to be continued according to the printed first and second pages and a rotation printing to be performed by rotating the second page

20. The apparatus of claim 17, wherein the orientation comprises at least one of a zero-degree rotated orientation and a 180-degree rotated orientation.

21. The apparatus of claim 17, wherein the original document comprises at least one page.
